(19) United States
(12) Patent Application Publication
(10) Pub. No.: US 2026/0156007 A1
(43) Pub. Date: Jun. 4, 2026

(54) METHOD AND APPARATUS FOR WAKING UP AN ELECTRONIC CONTROL UNIT

(71) Applicants: HYUNDAI MOTOR COMPANY, Seoul (KR); KIA CORPORATION, Seoul (KR)

(72) Inventor: Seung Su Kim, Hwaseong-si (KR)

(73) Assignees: HYUNDAI MOTOR COMPANY, Seoul (KR); KIA CORPORATION, Seoul (KR)

(21) Appl. No.: 19/255,762

(22) Filed: Jun. 30, 2025

(30) Foreign Application Priority Data
Dec. 4, 2024 (KR) 10-2024-0178778

(51) Int. Cl. H04L 12/12

(52) U.S. Cl. CPC H04L 12/12

(57) ABSTRACT

A method for waking up an electronic control unit includes receiving a wakeup pulse from an electronic control unit that detects a wakeup event, when the wakeup event occurs and performing a wakeup to switch from a sleep mode to a normal operation mode. The method also includes receiving a first frame from the electronic control unit that detects the wakeup event and determining electronic control units related to the wakeup event based on the first frame. The method additionally includes receiving second frames from the electronic control units related to the wakeup event and determining, based on the second frames, whether the electronic control units related to the wakeup event are ready for communication and transmitting a beacon to the electronic control units related to the wakeup event, when the electronic control units related to the wakeup event are ready for communication.

### CROSS-REFERENCE TO RELATED APPLICATION

This application claims the benefit of and priority to Korean Patent Application No. 10-2024-0178778, filed on Dec. 4, 2024, the entire contents of which are hereby incorporated herein by reference.

### TECHNICAL FIELD

The present disclosure relates to a method and apparatus for waking up an electronic control unit. More specifically, the present disclosure relates to a method and apparatus for waking up only electronic control units that require wakeup among a plurality of electronic control units when an event requiring wakeup occurs in a multi-drop network.

### BACKGROUND

The content described in this section provides background information related to the present disclosure and does not constitute prior art.

An in-vehicle network (IVN) is a wired or wireless communication network between a sensor and an electronic control unit within a vehicle. Among IVNs, a 10BASE-T1S Ethernet network is a network that transmits data at the speed of 10 Mbps in an environment such as a vehicle where noise and electromagnetic waves exist. Unlike a conventional Ethernet network, the 10BASE-T1S Ethernet network facilitates data transmission over a single channel. The 10BASE-T1S Ethernet network supports a multi-drop network. The multi-drop network is a network that connects multiple electronic control units to a single communications line.

In the multi-drop network, each electronic control unit may be in a sleep mode or a normal operation mode. The sleep mode is a state in which the electronic control unit stops operating, and the normal operation mode is a state in which the electronic control unit operates normally. Wakeup is the function of switching the electronic control unit from the sleep mode to the normal operation mode using a communication channel. When the electronic control unit in the sleep mode performs the wakeup by a wakeup pulse, there is a problem in that it is not possible to know the cause of the wakeup. Further, when an event occurs that requires waking up a specific electronic control unit, there is a problem that other unnecessary electronic control units also wake up.

### SUMMARY

In view of the above, embodiments of the present disclosure ensure that only electronic control units requiring a wakeup maintain a normal operation mode and electronic control units for which a wakeup is unnecessary are switched to a sleep mode, when an event requiring the wakeup occurs in a multi-drop network.

Further, embodiments of the present disclosure enable transmission and reception of a beacon, when all of electronic control units requiring a wakeup are in a communicable state.

The objectives to be achieved by the present disclosure are not limited to the above-mentioned objectives. Other objectives that are not mentioned herein should be more clearly understood by those having ordinary skill in the art from the following description.

According to an embodiment, a method performed by a coordinate electronic control unit is provided. The method includes receiving a wakeup pulse from an electronic control unit that detects a wakeup event, when the wakeup event occurs and performing a wakeup to switch from a sleep mode to a normal operation mode. The method also includes receiving a first frame from the electronic control unit that detects the wakeup event and determining electronic control units, among a plurality of electronic control units, related to the wakeup event based on the first frame. The method additionally includes receiving second frames from the electronic control units related to the wakeup event and determining, based on the second frames, whether the electronic control units related to the wakeup event are ready for communication. The method further includes transmitting a beacon to the electronic control units related to the wakeup event, based on determining that the electronic control units related to the wakeup event are ready for communication.

According to another embodiment, a method performed by an electronic control unit among a plurality of electronic control units is provided. The method includes detecting a wakeup event, when the wakeup event occurs and performing a wakeup to switch from a sleep mode to a normal operation mode. The method also includes transmitting a wakeup pulse to a coordinate electronic control unit and other electronic control units among the plurality of electronic control units, determining electronic control units related to the wakeup event among the plurality of electronic control units based on a feature table, wherein the feature table indicates electronic control units that require wakeup for each wakeup event. The method additionally includes transmitting a first frame to the coordinate electronic control unit and the other electronic control units among the plurality of electronic control units. The method further includes transmitting a second frame to the coordinate electronic control unit and receiving a beacon from the coordinate electronic control unit, based on the electronic control units related to the wakeup event being ready for communication.

According to yet another embodiment, a method performed by a first electronic control unit among a plurality of electronic control units is provided. The method includes receiving a wakeup pulse from a second electronic control unit that detects a wakeup event, when the wakeup event occurs and performing wakeup to switch from a sleep mode to a normal operation mode. The method also includes receiving a first frame from the second electronic control unit that detects the wakeup event and determining, based on the first frame, whether to maintain the normal operation mode. The method additionally includes transmitting a second frame to a coordinate electronic control unit, when the normal operation mode is maintained. The method further includes receiving a beacon from the coordinate electronic control unit, based on electronic control units related to the wakeup event being ready for communication.

According to still another embodiment, a coordinate electronic control unit is provided. The coordinate electronic control unit includes a memory and a plurality of processors. At least one processor among the plurality of processors is configured to receive a wakeup pulse from an electronic control unit that detects a wakeup event, when the wakeup event occurs and perform a wakeup to switch from a sleep mode to a normal operation mode. The at least one processor is also configured to receive a first frame from the electronic control unit that detects the wakeup event and determine electronic control units related to the wakeup event based on the first frame. The at least one processor is additionally configured to receive second frames from the electronic control units related to the wakeup event and use the second frames to determine whether the electronic control units related to the wakeup event are ready for communication. The at least one processor is further configured to transmit a beacon to the electronic control units related to the wakeup event, when the electronic control units related to the wakeup event are ready for communication.

According to embodiments of the present disclosure, there is an effect of reducing power consumption by maintaining only electronic control units, which require a wakeup in a multi-drop network, in a normal operation mode.

Further, according to embodiments of the present disclosure, there is an effect of ensuring synchronization by allowing all of electronic control units requiring a wakeup to transmit and receive a beacon in a communicable state.

Effects of the present disclosure are not limited to the above-mentioned effects. Other effects that are not mentioned herein should be more clearly understood by those having ordinary skill in the art from the following description.

### BRIEF DESCRIPTION OF THE DRAWINGS

FIG. 1 is a diagram illustrating a multi-drop network for a vehicle according to an embodiment of the present disclosure.

FIG. 2 is a block diagram illustrating a coordinate electronic control unit according to an embodiment of the present disclosure.

FIG. 3 is a block diagram illustrating a follower electronic control unit according to an embodiment of the present disclosure.

FIG. 4 is a diagram illustrating a frame according to an embodiment of the present disclosure.

FIG. 5 is a diagram illustrating a process for ensuring that only an electronic control unit requiring a wakeup is in a normal operation mode, according to an embodiment of the present disclosure.

FIG. 6 is a flowchart illustrating a process in which an electronic control unit detects a wakeup event and then performs wakeup and communication according to an embodiment of the present disclosure.

FIG. 7 is a flowchart illustrating a process in which a coordinate electronic control unit performs wakeup and communication according to an embodiment of the present disclosure.

FIG. 8 is a flowchart illustrating a process in which a follower electronic control unit performs wakeup and communication according to an embodiment of the present disclosure.

### DETAILED DESCRIPTION

Hereinafter, some example embodiments of the present disclosure are described in detail with reference to the accompanying drawings. In the accompanying drawings, like reference numerals may be used to designate like elements, even when the elements are shown in different drawings. Further, in the following description, wherein it was determined that a detailed description of known functions and configurations would unnecessarily obscure the gist of the present disclosure, the detailed description there has been omitted.

In the present disclosure, various terms such as “first”, “second”, “A”, “B”, “(a)”, “(b)”, etc., may be used. These terms are merely intended to differentiate one component from another. These terms do not to necessarily imply or suggest the substances, order, or sequence of the components. Throughout this specification, when a part ‘includes’ or ‘comprises’ a component, the part is meant to possibly further include other components, not to exclude thereof unless specifically stated to the contrary. The terms such as ‘unit’, ‘module’, and the like may refer to one or more units for processing at least one function or operation, which may be implemented by hardware, software, or a combination thereof.

In the present disclosure, when a component, controller, device, element, apparatus, or the like of the present disclosure is described as having a purpose or performing an operation, function, or the like, the component, controller, device, element, apparatus, or the like should be considered herein as being “configured to” meet that purpose or to perform that operation or function. Each component, controller, device, element, module, apparatus, server, and the like may separately embody or be included with a processor and a memory, such as a non-transitory computer readable media, as part of the apparatus.

The following detailed description, together with the accompanying drawings, is intended to describe example embodiments of the present disclosure, and is not intended to represent the only embodiments in which the present disclosure may be practiced.

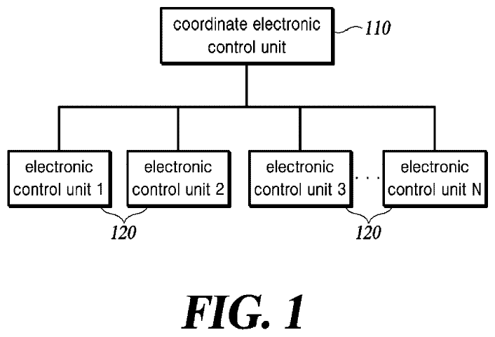

FIG. 1 is a diagram illustrating a multi-drop network for a vehicle, according to an embodiment of the present disclosure.

Referring to FIG. 1, a plurality of electronic control units are provided in the vehicle. The plurality of electronic control units may include a coordinate electronic control unit 110 and N follower electronic control units 120. The coordinate electronic control unit 110 and the N follower electronic control units 120 may transmit and receive data based on the multi-drop network. The coordinate electronic control unit 110 and the N follower electronic control units 120 may transmit and receive data using one communication line. The coordinate electronic control unit 110 and the N follower electronic control units 120 may transmit and receive data using a Media Dependent Interface (MDI). In an embodiment, the transmitted and received data may include a beacon and a frame.

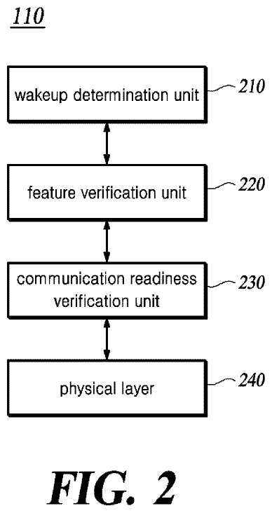

FIG. 2 is a block diagram illustrating the coordinate electronic control unit according to an embodiment of the present disclosure.

Referring to FIG. 2, the coordinate electronic control unit 110 includes all or some of a wakeup determination unit 210, a feature verification unit 220, a communication readiness verification unit 230, and/or a physical layer 240. The coordinate electronic control unit 110 and each component thereof may be implemented in hardware or software, or in a combination of hardware and software. Further, the function of each component may be implemented in software, and one or more processors may be implemented to execute the function of software corresponding to each component.

The wakeup determination unit 210 may detect a wakeup event or may receive a wakeup pulse to determine whether to perform wakeup. The wakeup event may be an event that should switch the electronic control unit from a sleep mode to a normal operation mode. For example, the wakeup event may include a user approaching the vehicle with a key, activating an air purification function, or activating an autonomous driving mode. The wakeup pulse may be data that is transmitted or received to wake up the electronic control unit. When the wakeup determination unit 210 determines to perform wakeup, the coordinate electronic control unit 110 may perform wakeup to switch from the sleep mode to the normal operation mode. When the wakeup determination unit 210 detects the wakeup event, the wakeup determination unit 210 may request a list of the electronic control units related to the wakeup event from the feature verification unit 220. The wakeup determination unit 210 may receive the list of the electronic control units related to the wakeup event from the feature verification unit 220. The list of the electronic control units related to the wakeup event may be a list of electronic control units that require wakeup when the wakeup event occurs. The wakeup determination unit 210 may transmit the list of the electronic control units related to the wakeup event to the physical layer 240.

The feature verification unit 220 may manage a feature table. The feature table may be a table that represents electronic control units requiring wakeup for each wakeup event. All the electronic control units existing in a single communication channel may have the same feature table. When the feature verification unit 220 receives a request from the wakeup determination unit 210 for the list of the electronic control units related to the wakeup event, the feature verification unit 220 may use the feature table to transmit the list of the electronic control units that require wakeup upon detection of the wakeup event to the wakeup determination unit 210.

The communication readiness verification unit 230 may check whether the electronic control units that require wakeup upon the occurrence of the wakeup event have completed their communication readiness. When the electronic control units requiring the wakeup are ready for communication, the communication readiness verification unit 230 may transmit data indicating that the electronic control units requiring wakeup are ready for communication to the physical layer 240. The communication readiness verification unit 230 may determine that communication readiness is complete when it receives all acknowledgements (ACKs) included in the frame from the electronic control units requiring wakeup.

The physical layer 240 may transmit wakeup pulses to other electronic control units and may transmit a frame to, and receive a frames from, the other electronic control units. When the electronic control units requiring wakeup are ready for communication, the physical layer 240 may transmit the beacon to the electronic control units in normal operation mode.

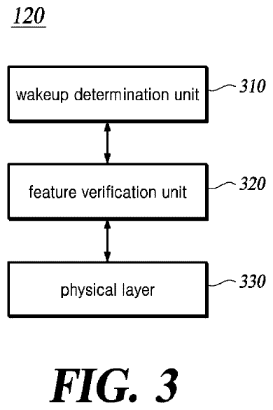

FIG. 3 is a block diagram illustrating a follower electronic control unit according to an embodiment of the present disclosure.

Referring to FIG. 3, each of the N follower electronic control units 120 includes all or some of a wakeup determination unit 310, a feature verification unit 320, and/or a physical layer 330. The follower electronic control unit 120 and each component thereof may be implemented in hardware or software, or in a combination of hardware and software. Further, the function of each component may be implemented in software, and one or more processors may be implemented to execute the function of software corresponding to each component.

The wakeup determination unit 310 may detect a wakeup event or may receive a wakeup pulse to determine whether to perform wakeup. When the wakeup determination unit 310 determines to perform wakeup, the follower electronic control unit 120 may perform wakeup to switch from the sleep mode to the normal operation mode. When the wakeup determination unit 310 detects the wakeup event, the wakeup determination unit 310 may request a list of the electronic control units related to the wakeup event from the feature verification unit 320. The wakeup determination unit 310 may receive the list of the electronic control units related to the wakeup event from the feature verification unit 320. The wakeup determination unit 310 may transmit the list of the electronic control units related to the wakeup event to the physical layer 330.

The feature verification unit 320 may manage a feature table. When the feature verification unit 320 receives a request from the wakeup determination unit 310 for the list of the electronic control units related to the wakeup event, the feature verification unit 320 may use the feature table to transmit the list of the electronic control units that require wakeup upon detection of the wakeup event to the wakeup determination unit 310. The physical layer 330 may transmit wakeup pulses to other electronic control units and may transmit a frame to, and receive a frames from, the other electronic control units.

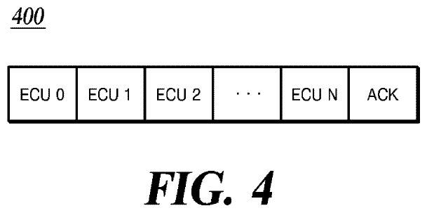

FIG. 4 is a diagram illustrating the frame according to an embodiment of the present disclosure.

Referring to FIG. 4, the coordinate electronic control unit 110 and the N follower electronic control units 120 may transmit and receive a frame 400, in an embodiment. The frame 400 may include information (e.g., ECU) indicating whether the wakeup is required for each electronic control unit and information (e.g., ACK) indicating whether communication readiness is complete.

A node ID represents an ID assigned to the coordinate electronic control unit 110 and the N follower electronic control units 120. The node and the electronic control unit may have the same meaning. The node ID of the coordinate electronic control unit 110 may be assigned 0, and the node IDs of the N follower electronic control units 120 may be assigned from 1 to N. If the coordinate electronic control unit 110 needs to perform wakeup, the ECU 0 may have a first value (e.g., 1). If the coordinate electronic control unit 110 does not need to perform wakeup, the ECU 0 may have a second value (e.g., 0). If the follower ECU with the node ID of 1 needs to perform wakeup, the ECU 1 may have the first value (e.g., 1). If the follower ECU with node ID of 1 does not need to perform wakeup, the ECU 1 may have the second value (e.g., 0). If the follower ECU with the node ID of 2 needs to perform wakeup, the ECU 2 may have the first value (e.g., 1). If the follower ECU with node ID of 2 does not need to perform wakeup, the ECU 2 may have the second value (e.g., 0). If the follower ECU with the node ID of N needs to perform wakeup, the ECU N may have the first value (e.g., 1). If the follower ECU with node ID of N does not need to perform wakeup, the ECU 2 may have the second value (e.g., 0).

When a particular electronic control unit is ready for communication, the ACK may be the first value (e.g., 1). When a particular electronic control unit is not ready for communication, the ACK may be the second value (e.g., 0). The ACK included in the frame transmitted by the electronic control unit detecting the wakeup event to other electronic control units may be the second value (e.g., 0). The ACK included in the frame transmitted to the coordinate electronic control unit 110 after the electronic control unit requiring wakeup maintains the normal operation mode may be the first value (e.g., 1).

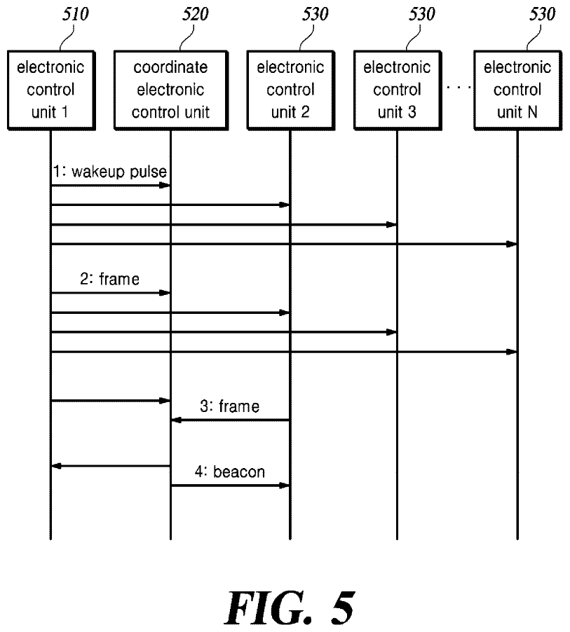

FIG. 5 is a diagram illustrating a process for ensuring that only the electronic control unit requiring the wakeup is in a normal operation mode, according to an embodiment of the present disclosure.

Referring to FIG. 5, when a first electronic control unit 510 detects the wakeup event and performs the wakeup, the first electronic control unit 510 transmits a wakeup pulse 1 to a coordinate electronic control unit 520 and the remaining electronic control units 530. All electronic control units may be in sleep mode before the first electronic control unit 510 detects the wakeup event. The coordinate electronic control unit 520 receiving the wakeup pulse and the remaining electronic control units 530 receiving the wakeup pulse may perform wakeup to switch from the sleep mode to the normal operation mode. The first electronic control unit 510 transmits the frame 2 to the coordinate electronic control unit 520 and the remaining electronic control units 530. In an embodiment, the frame may include information (e.g., ECU) indicating whether the wakeup is required for each electronic control unit and information (e.g., ACK) indicating whether communication readiness is complete.

When the wakeup event occurs and the electronic control unit requiring wakeup is an electronic control unit 510 having the node ID of 1 and the electronic control unit having the node ID of 2, the frame transmitted by the first electronic control unit 510 may include ECU 0 having the first value (e.g., 1), ECU 1 having the first value (e.g., 1), ECU 2 having the first value (e.g., 1), and ACK having the second value (e.g., 0). Information indicating whether the electronic control units with node IDs from 3 to N within the frame require wakeup may be the second value (e.g., 0). The first electronic control unit 510 maintains the normal operation mode, and the coordinate electronic control unit 520 receiving the frame and the electronic control unit with the node ID of 2 among the remaining electronic control units 530 receiving the frame may maintain the normal operation mode. Among the remaining electronic control units 530 that have received the frame, the electronic control units excluding the electronic control unit with the node ID of 2 may switch from normal operation mode to sleep mode.

Among the first electronic control unit 510 and the remaining electronic control units 530, the electronic control unit with the node ID of 2 transmits the frame 3 to the coordinate electronic control unit 520. In an embodiment, the frame transmitted by the first electronic control unit 510 may include the ECU 1, which is the first value (e.g., 1), and the ACK, which is the first value (e.g., 1). All information indicating whether electronic control units other than the first electronic control unit 510 require wakeup within the frame transmitted by the first electronic control unit 510 may be the second value (e.g., 0). The frame transmitted by the electronic control unit with the node ID of 2 may include the ECU 2 having the first value (e.g., 1) and the ACK having the first value (e.g., 1). All information indicating whether electronic control units other than the electronic control unit with the node ID of 2 need to wake up within the frame transmitted by the electronic control unit with the node ID of 2 may be the second value (e.g., 0).

When the coordinate electronic control unit 520 receives the frame including the ACK having the first value (e.g., 1) from the first electronic control unit 510 and the electronic control unit having the node ID of 2, the coordinate electronic control unit 520 transmits the beacon 4 to the first electronic control unit 510 and the electronic control unit having the node ID of 2. When the coordinate electronic control unit 520 receives the ACK, which is the first value (e.g., 1) in the frame transmitted by the first electronic control unit 510 and the ACK, which is the first value (e.g., 1) in the frame transmitted by the electronic control unit with the node ID of 2, it is determined that the first electronic control unit 510 and the electronic control unit with the node ID of 2 are ready for communication.

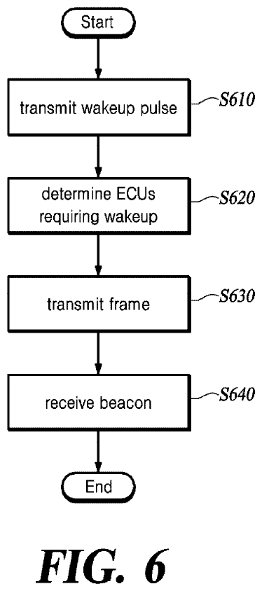

FIG. 6 is a flowchart illustrating a process in which the electronic control unit detects the wakeup event and then performs wakeup and communication according to an embodiment of the present disclosure.

Referring to FIG. 6, when the wakeup event occurs, a specific electronic control unit among the electronic control units mounted in the vehicle may detect the wakeup event. The electronic control unit that detects the wakeup event performs wakeup and switches from the sleep mode to the normal operation mode. In an operation S610, the electronic control unit that detects the wakeup event transmits the wakeup pulse to the coordinate electronic control unit and the remaining electronic control units. The coordinate electronic control unit and the remaining electronic control units may receive the wakeup pulse and perform wakeup to switch from the sleep mode to the normal operation mode.

In an operation S620, The electronic control unit that detects the wakeup event uses the feature table to determine the electronic control units that require wakeup. The electronic control units requiring wakeup may be electronic control units related to the wakeup event. In an operation S630, the electronic control unit that detects the wakeup event transmits the frame to the coordinate electronic control unit and the remaining electronic control units. The electronic control units that require wakeup may maintain the normal operation mode after receiving the frame. The electronic control units that do not require wakeup may switch from the normal operation mode to the sleep mode after receiving the frame. In an operation S640, when all the electronic control units requiring wakeup are ready for communication, the electronic control unit that detects the wakeup event receives the beacon from the coordinate electronic control unit.

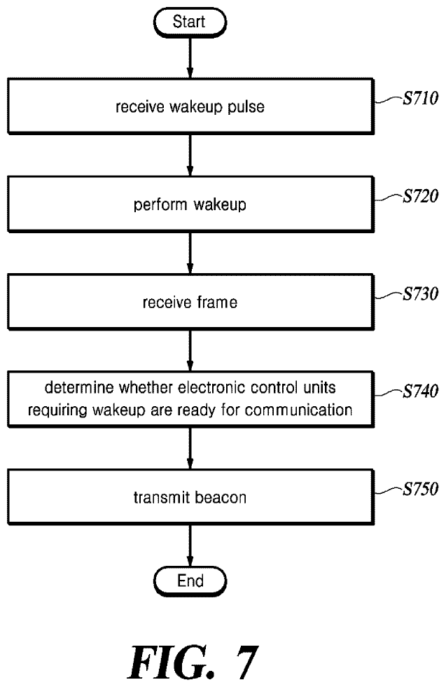

FIG. 7 is a flowchart illustrating a process in which the coordinate electronic control unit performs wakeup and communication according to an embodiment of the present disclosure.

Referring to FIG. 7, in an operation S710, when the wakeup event occurs, the coordinate electronic control unit receives the wakeup pulse from the electronic control unit that detects the wakeup event. In an operation S720, the coordinate electronic control unit performs wakeup to switch from the sleep mode to the normal operation mode. In an operation S730, the coordinate electronic control unit receives the frame from the electronic control unit that detects the wakeup event. The coordinate electronic control unit may determine which electronic control units require wakeup using the frame received from the electronic control unit that detects the wakeup event.

In an operation S740, the coordinate electronic control unit determines whether the electronic control units requiring wakeup are ready for communication. The coordinate electronic control unit may determine that all electronic control units requiring wakeup are ready for communication when it receives the frame including the ACK with the first value (e.g., 1) from all electronic control units requiring wakeup. In an operation S750, then the electronic control units requiring wakeup are ready for communication, the coordinate electronic control unit transmits the beacon to the electronic control units requiring wakeup.

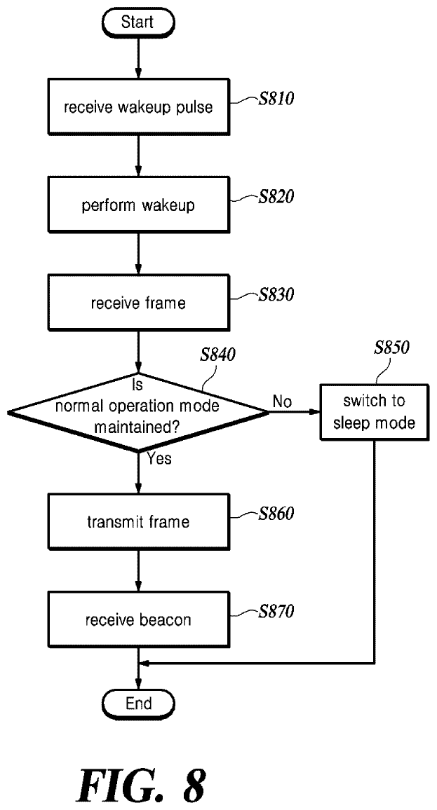

FIG. 8 is a flowchart illustrating a process in which the follower electronic control unit performs wakeup and communication according to an embodiment of the present disclosure.

Referring to FIG. 8, in an operation S810, when the wakeup event occurs, the follower electronic control unit receives the wakeup pulse from the electronic control unit that detects the wakeup event. In an operation S820, the follower electronic control unit performs wakeup to switch from the sleep mode to the normal operation mode. In an operation S830, the follower electronic control unit receives the frame from the electronic control unit that detects the wakeup event. In an operation S840, the follower electronic control unit uses the frame to determine whether to maintain the normal operation mode. The follower electronic control unit may determine whether to maintain the normal operation mode using information indicating whether the electronic control unit of the node ID assigned to it within the received frame requires wakeup.

When it is determined that the normal operation mode is not maintained (NO in the operation S840), the follower electronic control unit switches from the normal operation mode to the sleep mode in an operation S850. When it is determined that the normal operation mode is maintained (YES in the operation S840), the follower electronic control unit maintains the normal operation mode and transmits the frame to the coordinate electronic control unit in an operation S860. The frame transmitted by the follower electronic control unit may include the ACK with the first value (e.g., 1). In an operation S870, when the electronic control units requiring wakeup are ready for communication, the follower electronic control unit receives the beacon from the coordinate electronic control unit.

Each element of the apparatus or method in accordance with embodiments of the present disclosure may be implemented in hardware or software, or a combination of hardware and software. The functions of the respective elements may be implemented in software, and a microprocessor may be implemented to execute the software functions corresponding to the respective elements.

Various embodiments of systems and techniques described herein may be realized with digital electronic circuits, integrated circuits, field programmable gate arrays (FPGAs), application specific integrated circuits (ASICs), computer hardware, firmware, software, and/or combinations thereof. The various embodiments may include implementation with one or more computer programs that are executable on a programmable system. The programmable system may include at least one programmable processor, which may be a special purpose processor or a general purpose processor, coupled to receive and transmit data and instructions from and to a storage system, at least one input device, and at least one output device. Computer programs (also known as programs, software, software applications, or code) may include instructions for a programmable processor and may be stored in a storage medium or “computer-readable recording medium.”

The computer-readable recording medium may include all types of storage devices on which computer-readable data may be stored. The computer-readable recording medium may be a non-volatile or non-transitory medium such as a read-only memory (ROM), a compact disc ROM (CD-ROM), magnetic tape, a floppy disk, a memory card, a hard disk, or an optical data storage device. In addition, the computer-readable recording medium may further include a transitory medium such as a data transmission medium. Furthermore, the computer-readable recording medium may be distributed over computer systems connected through a network, and computer-readable program code may be stored and executed in a distributive manner.

Although operations are illustrated in the flowcharts/timing charts in this specification as being sequentially performed, this is merely an example description of the technical idea of one embodiment of the present disclosure. In other words, those of ordinary skill in the art to which the present disclosure pertains would appreciate that various modifications and changes may be made without departing from essential features of the present disclosure. For example, the sequence illustrated in the flowcharts/timing charts may be changed and one or more operations of the operations may be performed in parallel. Thus, flowcharts/timing charts are not limited to the temporal order.

Although example embodiments of the present disclosure have been described for illustrative purposes, those having ordinary skill in the art should appreciate that various modifications, additions, and substitutions are possible, without departing from the idea and scope of the present disclosure and the claims. Therefore, example embodiments of the present disclosure have been described for the sake of brevity and clarity. The scope of the technical idea of the present embodiments is not limited by the illustrations. Accordingly, one of ordinary skill in the art should understand that the scope of the present disclosure is not to be limited by the above explicitly described embodiments but by the claims and equivalents thereof.

What is claimed is:

1. A method performed by a coordinate electronic control unit, the method comprising:
receiving a wakeup pulse from an electronic control unit that detects a wakeup event, when the wakeup event occurs;
performing a wakeup to switch from a sleep mode to a normal operation mode;
receiving a first frame from the electronic control unit that detects the wakeup event;
determining electronic control units, among a plurality of electronic control units, related to the wakeup event based on the first frame;
receiving second frames from the electronic control units related to the wakeup event;
determining, based on the second frames, whether the electronic control units related to the wakeup event are ready for communication; and
transmitting a beacon to the electronic control units related to the wakeup event, based on determining that the electronic control units related to the wakeup event are ready for communication.

2. The method of claim 1, wherein each of the first frame and the second frames includes information indicating whether wakeup is required for each electronic control unit among the plurality of electronic units and information indicating whether communication readiness is complete.

3. The method of claim 2, wherein:
the information indicating whether the wakeup of the electronic control units related to the wakeup event is required within the first frame has a first value; and
the information indicating whether the communication readiness is complete within the first frame has a second value.

4. The method of claim 2, wherein:
the information indicating whether the wakeup of the electronic control units related to the wakeup event is required within the second frames has a first value; and
the information indicating whether the communication readiness is complete within the second frames has the first value.

5. A method performed by an electronic control unit among a plurality of electronic control units, the method comprising:
detecting a wakeup event, when the wakeup event occurs;
performing a wakeup to switch from a sleep mode to a normal operation mode;
transmitting a wakeup pulse to a coordinate electronic control unit and other electronic control units among the plurality of electronic control units;
determining electronic control units related to the wakeup event among the plurality of electronic control units based on a feature table, wherein the feature table indicates electronic control units that require wakeup for each wakeup event;
transmitting a first frame to the coordinate electronic control unit and the other electronic control units among the plurality of electronic control units;
transmitting a second frame to the coordinate electronic control unit; and
receiving a beacon from the coordinate electronic control unit, based on the electronic control units related to the wakeup event being ready for communication.

6. The method of claim 5, wherein each of the first frame and the second frame includes information indicating whether wakeup is required for each electronic control unit among the plurality of electronic control units and information indicating whether communication readiness is complete.

7. The method of claim 6, wherein:
the information indicating whether the wakeup of the electronic control units related to the wakeup event is required within the first frame has a first value; and
the information indicating whether the communication readiness is complete within the first frame has a second value.

8. The method of claim 6, wherein:
the information indicating whether the wakeup of the electronic control unit is required within the second frames has a first value; and
the information indicating whether the communication readiness is complete within the second frame has the first value.

9. A method performed by a first electronic control unit among a plurality of electronic control units, the method comprising:
receiving a wakeup pulse from a second electronic control unit, among the plurality of electronic control units, that detects a wakeup event, when the wakeup event occurs;
performing wakeup to switch from a sleep mode to a normal operation mode;
receiving a first frame from the second electronic control unit that detects the wakeup event;
determining, based on the first frame, whether to maintain the normal operation mode;
transmitting a second frame to a coordinate electronic control unit, when the normal operation mode is maintained; and
receiving a beacon from the coordinate electronic control unit, based on electronic control units related to the wakeup event being ready for communication.

10. The method of claim 9, wherein each of the first frame and the second frame includes information indicating whether wakeup is required for each electronic control unit among the plurality of electronic control units and information indicating whether communication readiness is complete.

11. The method of claim 10, wherein:
the information indicating whether the wakeup of the electronic control units related to the wakeup event is required within the first frame has a first value; and
the information indicating whether the communication readiness is complete within the first frame has a second value.

12. The method of claim 10, wherein:
the information indicating whether the wakeup of the first electronic control unit is required within the second frames has a first value; and
the information indicating whether the communication readiness is complete within the second frame has the first value.

13. A coordinate electronic control unit comprising:
a memory storing computer-readable instructions; and
at least one processor configured to execute the computer-readable instructions, wherein the at least one processor is configured to:
receive a wakeup pulse from an electronic control unit, among a plurality of electronic control units, that detects a wakeup event, when the wakeup event occurs,
perform a wakeup to switch from a sleep mode to a normal operation mode,
receive a first frame from the electronic control unit that detects the wakeup event,
determine, based on the first frame, electronic control units, among the plurality of electronic control units, related to the wakeup event;
receive second frames from the electronic control units related to the wakeup event,
determine, based on the second frames, whether the electronic control units related to the wakeup event are ready for communication; and
transmit a beacon to the electronic control units related to the wakeup event, based on determining that the electronic control units related to the wakeup event are ready for communication.

14. The coordinate electronic control unit of claim 13, wherein each of the first frame and the second frames includes information indicating whether wakeup is required for each electronic control unit among the plurality of electronic control units and information indicating whether communication readiness is complete.

15. The coordinate electronic control unit of claim 14, wherein:
the information indicating whether the wakeup of the electronic control units related to the wakeup event is required within the first frame has a first value; and
the information indicating whether the communication readiness is complete within the first frame has a second value.

16. The coordinate electronic control unit of claim 14, wherein:
the information indicating whether the wakeup of the electronic control units related to the wakeup event is required within the second frames has a first value; and
the information indicating whether the communication readiness is complete within the second frames has the first value.
